(19) United States
(12) Patent Application Publication
(10) Pub. No.: US 2011/0265375 A1
(43) Pub. Date: Nov. 3, 2011

(54) TOPIARY FORM

(76) Inventor: VICTOR PICCOLOMINI, Ijamsville, MD (US)

(21) Appl. No.: 12/956,970

(22) Filed: Nov. 30, 2010

Related U.S. Application Data
(60) Provisional application No. 61/282,955, filed on Apr. 29, 2010.

(51) Int. Cl. A01G 9/12

(52) U.S. Cl. 47/45

(57) ABSTRACT

The topiary form includes a wire frame having a predetermined shape. The wire frame includes two halves connected together by a plurality of hooks and loops or eyeholes. The two halves are pivotal on at least one of the hooked connections, allowing the halves to easily wrap around the topiary to be shaped and to be easily removed.

### CROSS-REFERENCE TO RELATED APPLICATION

This application claims the benefit of U.S. Provisional Patent Application Ser. No. 61/282,955, filed Apr. 29, 2010.

### BACKGROUND OF THE INVENTION

1. FIELD OF THE INVENTION

The present invention relates to horticultural accessories, and more particularly to a topiary form for creating uniformly shaped shrubs.

2. DESCRIPTION OF THE RELATED ART

Many property owners prefer to have ornamental topiary on their property as part of the landscaping design, including plantings in the yards or the gardens. Such topiary provides aesthetic appeal enhancing property values as well as a reflection of the owner's moods or whims. While visually appealing, the task of making and maintaining such topiary can be very labor intensive, costly and prone to non-uniformity in the shapes of the bushes and shrubbery when performed by the average property owner.

One of the solutions to the above involves using a preform topiary cage having a predetermined shape. The typical preform topiary cage tends to be open yet rigidly constructed so as to confine the growth of the bush into the shape, e.g., a wire mesh surrounding a frame. The preform cage is usually installed on the bush or shrub to be shaped in a semi-permanent manner with heavy gauge wire twist ties or screws. However, these types of fasteners tend to increase the difficulty in removing the cage. As a result, if the user desires to have several bushes with the same shape, then the user may deem it easier, despite the additional expenses, to use a plurality of cages instead of a single cage that can be used on each bush. Thus, it would be a benefit in the art of landscaping to provide an economical topiary shaping aid with features for easy installation, maintenance and uniform shaping of bushes and shrubs.

Thus, a topiary form solving the aforementioned problems is desired.

### SUMMARY OF THE INVENTION

The topiary form includes a wire frame having a predetermined shape. The wire frame includes two halves connected together by a plurality of hooks and loops. The two halves are pivotal on at least one of the hooked connections allowing the halves to easily wrap around the bush or shrub to be shaped, and to be easily removed.

These and other features of the present invention will become readily apparent upon further review of the following specification and drawings.

### BRIEF DESCRIPTION OF THE DRAWINGS

FIG. 1 is an environmental, perspective view of a topiary form according to the present invention.

FIG. 2 is a perspective view of the topiary form according to the present invention in an open state for installation.

FIG. 3 is an enlarged, perspective view of the fasteners for the topiary form according to the present invention.

Similar reference characters denote corresponding features consistently throughout the attached drawings.

### DETAILED DESCRIPTION OF THE PREFERRED EMBODIMENTS

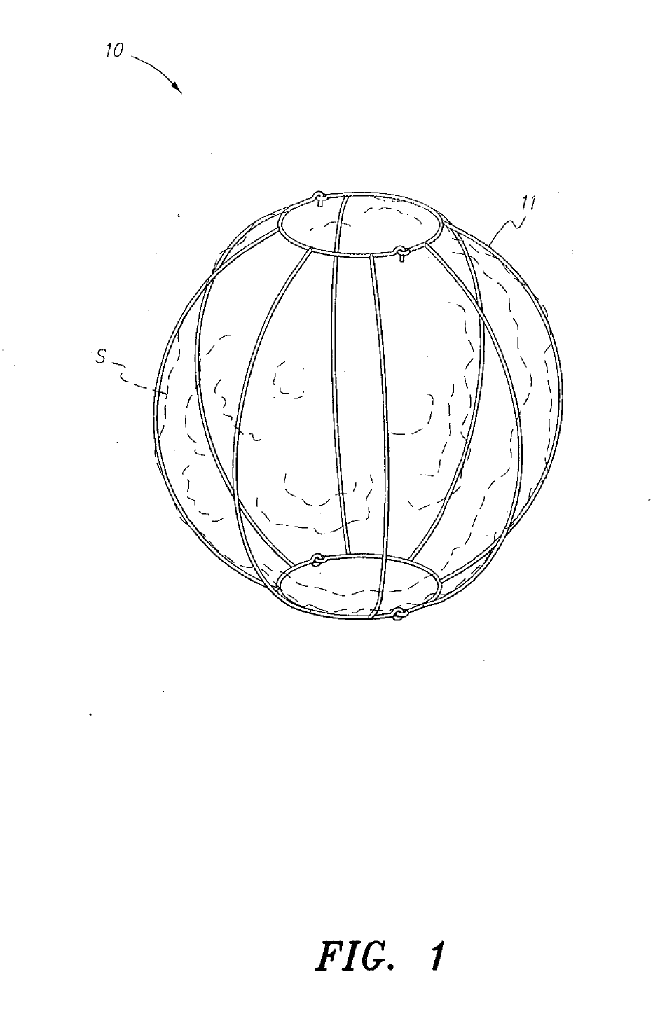

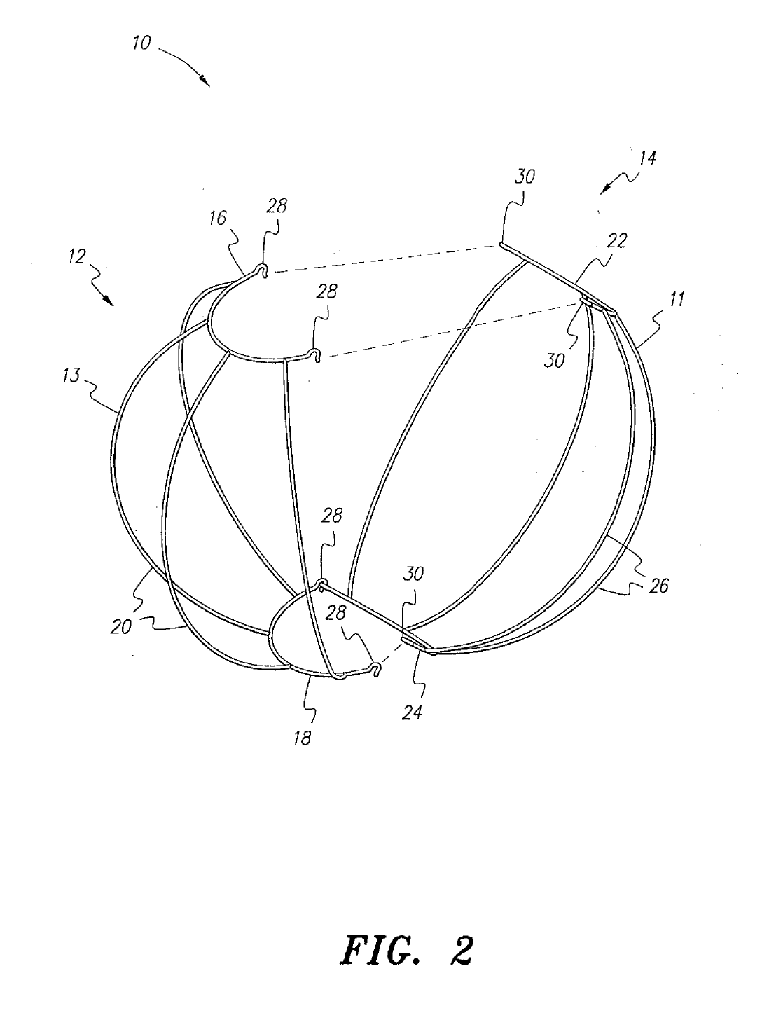

The present invention relates to a topiary form, generally referred to in the drawings by reference number 10, for easy installation and removal of the same to facilitate shaping of a plurality of shrubbery S into the same shape. As shown in FIGS. 1 and 2, the topiary form 10 includes a wire frame 11 having a particular shape. In the exemplary embodiment, the topiary form 10 is spherically shaped. The topiary form 10 may also include geometric, animal, plant or other shapes as desired.

Two hemispherical halves 12, 14 define the spherical shape. The first hemispherical half 12 includes a top semicircular frame 16 and a bottom semicircular frame 18 with a plurality of arcuate wire members 20 spanning the top and bottom semicircular frames 16, 18. Similarly, the second hemispherical half 14 includes a top semicircular frame 22 and a bottom semicircular frame 24 with a plurality of arcuate wire members 26 spanning the top and bottom semicircular frames 22, 24. Both the wire members 20 and 26 define a substantial portion of the spherical shape. Similar construction may be used to define other desired shapes. The spacing between the wire members 20 and 26 is preferably wide so as to prevent bunching of the shrub S.

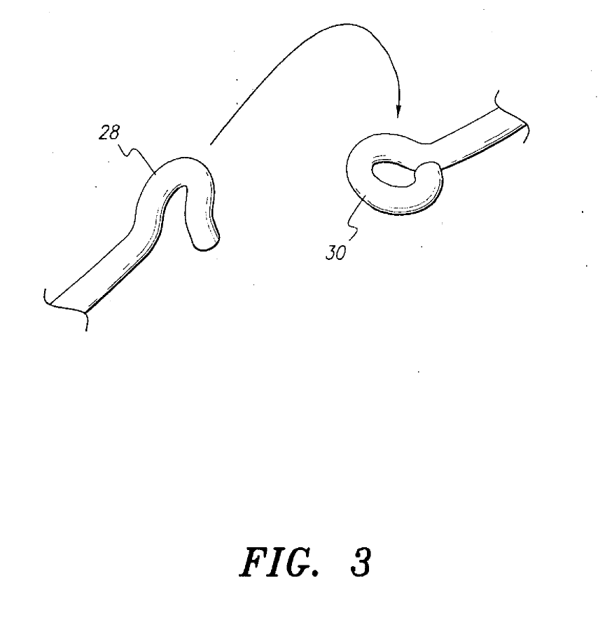

To enable the first and second hemispherical halves 12, 14 to be detachably mounted to each other, the top and bottom semicircular frames 16, 18 include hooks 28 in the first hemispherical half 12 at the distal ends. The top and bottom semicircular frames 22, 24 in the second hemispherical half 14 include corresponding loops or eyeholes 30 at the respective distal ends. As shown in FIG. 3, the simple fastening facilitated by the hooks 28 and the eyeholes 30 permits easy assembly and disassembly of the topiary form 10.

The following describes how to use the topiary form 10. In use, the two halves 12, 14 may be opened like a clam so the halves 12, 14 pivot about one pair of top and bottom hooked connections. A more preferable method is to open the halves 12, 14 about one of the lower hooked connections. Once opened, the topiary form 10 may be wrapped around the shrub or bush to be shaped and closed. With the preferred method, the topiary form 10 can be wrapped around the shrub from the bottom towards the top to follow the natural growth angles of branches, which results in an easier installation of the topiary form 10. Preferably, the hooks 28 and eyeholes 30 each respectively project away from the corresponding end wire members. Thus, when the topiary form 10 is closed about the bush or shrub, the adjacent end wire members of each half of the frame are spaced apart so as to prevent pinching of branches of the shrub or bush.

Once installed, the user may then trim around the topiary form 10 to obtain the desired shape. The topiary form 10 may be easily unhooked and installed in another shrub or bush to repeat the trimming process so that the same shape may be reproduced on a desired number of shrubs. Alternatively, the topiary form 10 may be installed on a shrub to guide or train the growth thereof into the desired shape. Additionally, it should be noted that, in addition to providing a form for trimming a bush or shrub into a desired topiary, the topiary form 10 further acts as a restrictive cage or frame for preventing unwanted growth of the shrub or bush, and to allow the shrub or bush to grow into a desired shape.

It is to be noted that the topiary form 10 encompasses a variety of alternatives. For example, the topiary form 10 is preferably made from steel, but other materials, such as wood and plastic, may also be viable alternatives. The topiary frame 10 may also be coated with a weather-resistant layer or weatherproof paint to resist wear from the environment.

It is to be understood that the present invention is not limited to the embodiments described above, but encompasses any and all embodiments within the scope of the following claims.

I claim:

1. A topiary form, comprising a wire frame having a predetermined shape, the wire frame having first and second half-sections, the first half-section having a plurality of hooks to latch the first section to the second section, the second half-section having a plurality of corresponding eyeholes for receiving the hooks, wherein at least one of the hook and eyehole pairs forms a pivotal connection for opening and closing the first and second half-sections with respect to each other for installation on a bush.

2. The topiary form as recited in claim 1, wherein each of said first and second half-sections includes a top frame portion, a bottom frame portion, and a plurality of wire members extending therebetween.

3. The topiary form as recited in claim 2, wherein said hooks are formed on opposing ends of each of said top and bottom frame portions of the first half-section.

4. The topiary form as recited in claim 3, wherein said eyeholes are formed on opposing ends of each of said top and bottom frame portions of the second half-section.

5. The topiary form as recited in claim 4, wherein each said wire member is substantially arcuate.

6. The topiary form as recited in claim 5, wherein each of said first and second half-sections is substantially convex.

7. The topiary form as recited in claim 6, wherein each of said top and bottom frame portions of the first and second half-sections is substantially semicircular.

8. The topiary form as recited in claim 7, wherein the wire frame is substantially spherical.

9. The topiary form as recited in claim I, wherein the wire frame is formed from steel.

10. The topiary form as recited in claim 1, further comprising a water-resistant coating disposed on the wire frame.

11. A topiary form, comprising a wire frame having .a predetermined shape, the wire frame including first and second half-sections, the first half-section having a plurality of hooks to releasably secure the first half-section to the second half-section, the second half-section having a plurality of corresponding eyeholes for receiving the plurality of hooks, wherein at least one of the hook and eyehole pairs forms a pivotal connection for opening and closing the first and second half-sections with respect to each other for installation on a bush, each of the first and second half-sections including a top frame portion, a bottom frame portion, and a plurality of wire members extending therebetween.

12. The topiary form as recited in claim 11, wherein said hooks are formed on opposing ends of each of said top and bottom frame portions of the first half-section.

13. The topiary form as recited in claim 12, wherein said eyeholes are formed on opposing ends of each of said top and bottom frame portions of the second half-section.

14. The topiary form as recited in claim 13, wherein each said wire member is substantially arcuate.

15. The topiary form as recited in claim 14, wherein each of said first and second half-sections is substantially convex.

16. The topiary form as recited in claim 15, wherein each of said top and bottom frame portions of the first and second half-sections is substantially semicircular.

17. The topiary form as recited in claim 16, wherein the wire frame is substantially spherical.

18. The topiary form as recited in claim 11, wherein the wire frame is formed from steel.

19. The topiary form as recited in claim 11, further comprising a water-resistant coating disposed on the wire frame.

20. A topiary form, comprising a wire frame having a. predetermined shape, the wire frame including convex first and second half-sections, the first half-section having a plurality of hooks to releasably secure the first half-section to the second half-section, the second half-section having a plurality of corresponding eyeholes for receiving the plurality of hooks, wherein at least one of the hook and eyehole pairs forms a pivotal connection for opening and closing the first and second half-sections with respect to each other for installation on a bush, each of the first and second half-sections including a top frame portion, a bottom frame portion, and a plurality of arcuate wire members extending therebetween, the hooks being formed on opposing ends of each of the top and bottom frame portions of the first half-section, and the eyeholes being formed on opposing ends of each of the top and bottom frame portions of the second half-section.
